(19) United States
(12) Patent Application Publication
(10) Pub. No.: US 2005/0151418 A1
(43) Pub. Date: Jul. 14, 2005

(54) Electrohydraulic braking system with a pedal travel simulator consisting of a spring loaded pressure cylinder and a mechanically coupled servo piston

(75) Inventors: Boris Bickel, Stuttgart (DE); Ekkehard Niemann, Hanau (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 10/497,687

(22) PCT Filed: Oct. 16, 2002
(86) PCT No.: PCT/EP02/11541

(30) Foreign Application Priority Data
Dec. 5, 2001 (DE) 101 59 789.4

(51) Int. Cl. B60T 8/88

(52) U.S. Cl. 303/122

(57) ABSTRACT

The invention relates to a return of the brake fluid out of the pedal travel simulator into the auxiliary brake circuit. For this purpose, a pedal travel simulator is designed as a spring-loaded cylinder with a coupled and activated hydraulic booster piston and with a strengthened compression spring. The compression spring conveys the brake fluid contained in the pedal travel simulator back into the auxiliary brake circuit of the electrohydraulic brake system. The spring force of the compression spring is dimensioned such that, when the piston of the pedal travel simulator is in its inlet-side end position, the pedal travel simulator has prevailing in it a minimum pressure which is sufficient to make it possible to adhere in the auxiliary brake circuit to the boundary conditions for the auxiliary brake system which are prescribed according to StVZO, EU directive 71/3210 EWG and ECE regulation 13. When the electrohydraulic brake system is operating normally, the pedal travel/pedal force characteristic of the pedal travel simulator is set via the hydraulic activation of a coupled hydraulic cylinder.

### BACKGROUND OF THE INVENTION

The present invention relates to a method and a device for the return of brake fluid out of a pedal travel simulator into the auxiliary brake circuit of an electrohydraulic brake system and to an electrohydraulic brake system and a pedal travel simulator.

An electrohydraulic brake system with a pedal travel simulator is described in detail, for example, in WO 99/29548. The pedal travel simulator is designed as a spring-loaded cylinder and contains a compression spring having a nonlinear force/travel characteristic. In conventional brake systems for passenger cars, the driver's braking force is transmitted mechanically by means of a lever step-up of the brake pedal to a vacuum brake booster and then, boosted, further on to the brake master cylinder. By means of the pressure generated, the desired braking action of the individual wheel brakes is achieved. In an electrohydraulic brake, this purely hydromechanical chain of action is interrupted and is replaced by sensors, a control apparatus and a pressure supply. There is, in normal operation, no mechanical or hydraulic connection between the brake pedal and the wheel brake.

An electrohydraulic brake includes an actuating unit consisting of brake pedal and of pedal travel simulator, a hydraulic assembly, sensors (for example, travel sensors, pressure sensors, wheel rotational speed sensors), mounted control apparatuses or remotely located control apparatuses for the hydraulic assembly, a pressure supply, control and pressure lines and hydraulic valves.

The basic operation of such an electrohydraulic brake can be summarized as follows. Two different sensors, namely a sensor on the actuating unit for the pedal travel and a pressure sensor on the hydraulic assembly, detect the braking requirement and transmit it to the control apparatus. This control apparatus also incorporates the functions of brake boosting, antilock system (ABS), traction control (ASR) and an electronic stability program (ESP) by means of software. The further sensors of ABS, ASR and ESP deliver to the control apparatus data relating to the driving state, such as speed or cornering, and relating to the state of movement of the individual wheels. From these data, the software of the control apparatus determines signals for the hydraulic assembly which are converted in the wheel pressure modulators into the brake pressures for the individual wheels. An electrically driven hydraulic pump with a high-pressure accumulator and with pressure monitoring forms the pressure supply.

During normal operation, the brake pedal acts on the brake master cylinder and on the following pedal travel simulator. The pedal travel simulator sets up a preferably nonlinear pedal force/pedal travel characteristic by means of a compression spring. For safety reasons, in the event of possible faults in the system, there is a switch into a state in which the vehicle can also be braked without brake assistance.

In known electrohydraulic brake systems, when a fault occurs, however, the components of the hydraulic assembly are separated from the purely hydromechanical auxiliary brake circuit. The vehicle is then brought to a standstill by the driver's muscular power. Brake fluid possibly contained in the spring-loaded piston of the pedal travel simulator remains unused during auxiliary braking. This state arises when, in known electrohydraulic brake systems, the electrohydraulic component fails during an already initiated braking operation and has to be switched over to the auxiliary brake circuit.

To be precise, in this case, the brake pedal has already still been depressed in normal operation and the brake fluid has already been conveyed for a large part out of the brake master cylinder into the pedal travel simulator. However, in known electrohydraulic brake systems, the brake fluid in the pedal travel simulator is no longer available for auxiliary braking, and it is doubtful whether the brake fluid still contained in the brake master cylinder is sufficient to make it possible to execute auxiliary braking. Even when the residual brake fluid which has remained in the brake master cylinder is sufficient for auxiliary braking, this being ensured in contemporary vehicles by structural measures, the pedal travel is nevertheless at all events lengthened during auxiliary braking, and this may lead to adverse ergonomic force conditions.

### SUMMARY OF THE INVENTION

An object according to the invention is to specify an improved electrohydraulic brake system and an improved pedal travel simulator in relation to the above-described prior art.

This object has been achieved, according to the invention, by recognizing that the solution arises from a return of the brake fluid out of the pedal travel simulator into the auxiliary brake circuit. For this purpose, a pedal travel simulator is configured as a spring-loaded cylinder with a coupled and activated hydraulic booster piston and with a strengthened compression spring. The compression spring conveys the brake fluid contained in the pedal travel simulator back into the auxiliary brake circuit of the electrohydraulic brake system. The spring force of the compression spring is dimensioned such that, when the piston of the pedal travel simulator is in its inlet-side end position, the pedal travel simulator is sufficient to make it possible to adhere in the auxiliary brake circuit to the boundary conditions for the auxiliary brake system which are prescribed according to StVZO, EU directive 71/3210 EWG and ECE regulation 13. When the electrohydraulic brake system is operating normally, the pedal travel/pedal force characteristic of the pedal travel simulator is set via the hydraulic activation of a coupled hydraulic cylinder.

In an emergency, therefore, when the electrohydraulic component of the brake system fails, the brake fluid contained in the pedal travel simulator is conveyed back into the auxiliary brake circuit by the strong compression spring in the spring-loaded cylinder of the pedal travel simulator. The return volume is consequently available for auxiliary braking and shortens the pedal travel for auxiliary braking. A release of the brake pedal, and therefore an interruption in the braking manoeuver in order to make it possible to return brake fluid out of the pedal travel simulator into the auxiliary brake circuit and subsequently block the piston of the pedal travel simulator are not necessary when the volume return according to the present invention is employed. The braking manoeuver can be carried out to the end without interruption.

There are no electrical auxiliary assemblies of any kind arranged in the auxiliary brake circuit. The auxiliary brake circuit consequently remains fully operational even in the event of a failure of the on-board electrical system in the motor vehicle.

The compression spring and the pedal travel simulator are dimensioned at least such and the compression spring is prestressed at least with a force such that, in order to actuate the pedal travel simulator and consequently compress the compression spring, a minimum brake pressure is necessary which is specific to the brake systems. Thereby a legally prescribed mean deceleration of, for example, 2.9 m/s² at the present time is at least achieved when the legally prescribed maximum pedal force of, for example, 500 N at the present time is applied.

Preferably, the compression spring is designed to be somewhat stronger than is absolutely necessary for the minimum brake pressure. Preferably, the pedal travel simulator and the compression spring are dimensioned such and the compression spring is prestressed with a force such that, in order to actuate the pedal travel simulator and consequently compress the compression spring, a pressure is necessary which is higher than the brake pressure which is specific to the brake systems and at which the wheels lock in the case of a maximum coefficient of static friction. This ensures, during auxiliary braking, that no brake fluid is conveyed from the auxiliary brake circuit into the pedal travel simulator, but, instead, all the brake fluid contained in the pedal travel simulator is conveyed into the auxiliary brake circuit even when the brake pedal is pressed.

The result of the high spring forces in the pedal travel simulator is that, when the brake system is operating normally, the pedal travel simulator has to be operated with the assistance of a booster piston. Consequently, the spring-loaded cylinder of the pedal travel simulator is coupled to a hydraulic cylinder which is connected hydraulically to the pressure supply and to the compensating reservoir of the brake system via two hydraulic valves, in particular two proportional valves. The hydraulic valves are activated by the control apparatus of the brake system according to a pedal travel/pedal force characteristic filed in the control apparatus.

### BRIEF DESCRIPTION OF THE DRAWINGS

These and other objects, features and advantages of the present invention will become more readily apparent from the following detailed description of currently preferred configurations thereof when taken in conjunction with the accompanying drawings wherein:

The sole FIGURE is a block diagram of an electrohydraulic brake system with a pedal travel simulator which is composed of a spring-loaded cylinder and of a hydraulic booster cylinder in accordance with the present invention.

### DETAILED DESCRIPTION OF THE DRAWINGS

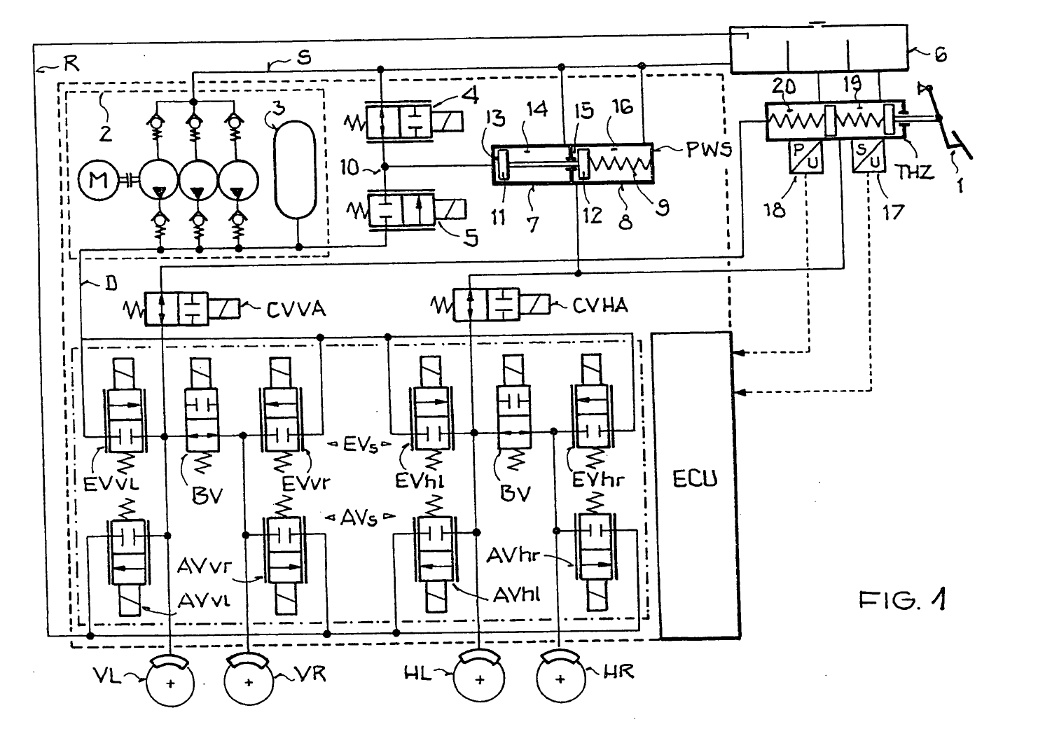

An electrohydraulic brake system according to FIG. 1 typically consists of the known components, including a pressure supply 2, a control apparatus ECU (Electronic Control Unit), a hydraulic assembly HCU (Hydraulic Control Unit) and an actuating unit consisting of a brake pedal 1, tandem brake master cylinder THZ and pedal travel simulator PWS.

During normal braking, the hydraulic assembly HCU is separated from the tandem brake master cylinder by isolating valves CVVA (Cut Valve front axle) and CVHA (Cut Valve rear axle). The hydraulic assembly typically contains a plurality of 2/2-way hydraulic solenoid valves, each with two setting possibilities and two hydraulic connections. For safety reasons, and according to legal licensing provisions, there must be at least two separate brake circuits for the service brake in a motor vehicle. In the simplified exemplary embodiment shown, these are the two brake circuits for the front axle, and for the rear axle of the vehicle. The brake circuit for the front axle is formed from an inlet valve, front left, EVvl and from an outlet valve, front left, AVvl and the wheel brake, front left, VL and also from an inlet valve, front right, EVvr, an outlet valve, front right, AVvr and the wheel brake, front right, VR. A compensating valve BV (Balance Valve) between the two inlet valves ensures pressure compensation between the left and the right wheel brake. The same arrangement of solenoid valves is also found for the rear axle in the hydraulic assembly. The brake circuit for the rear axle consists of an inlet valve, rear left, EVhl, an outlet valve, rear left, AVhl and the wheel brake, rear left, HL and of an inlet valve, rear right, Evhr, an outlet valve, rear right, Avhr and the wheel brake, rear right, HR. Once again, a compensating valve BV for pressure compensation between the left and the right side of the vehicle is also connected between the left and the right inlet valve.

All the valves are designed as electrically actuable activatable solenoid valves with automatic resetting and are activated by the control apparatus ECU of the electrohydraulic brake. The inlet valves and outlet valves of the hydraulic assembly are designed as proportional valves, since the brake pressure can be fed in the wheel brakes more effectively by means of proportional valves. The compensating valves, which are located in each case between the left wheel brake and the right wheel brake, make it possible, depending on the requirement of the driving situation, either to have pressure compensation between the left and the right wheel brakes or, in ABS, ASR and ESP applications, by the separation of the left and the right wheel brake, to have individual braking of the vehicle wheels.

The pressure supply 2 of the hydraulic assembly consists of a driven hydraulic pump, for example of a three-piston pump, which is connected to the brake fluid reservoir 6 by a suction line S and the pressure line D of which is connected to a pressure accumulator 3 and to the hydraulic assembly. The inlet valves of the hydraulic assembly are supplied with brake fluid and with brake pressure by the pressure supply. The outlet valves of the hydraulic assembly reduce the brake pressure again when they are opened. The outlet valves are therefore connected via a return line R to the brake fluid reservoir 6, into which the brake fluid flowing out of the outlet valves is returned.

During normal braking of the electrohydraulic brake system, the two brake circuits for front axle and rear axle are separated from the tandem brake master cylinder by two isolating valves CVVA, CVHA. When the brake pedal is actuated, the brake fluid is conveyed out of one of the pressure chambers of the tandem brake master cylinder into a pedal travel simulator which, as a rule, is configured as a hydraulically actuable spring-loaded cylinder. The driver performs work by the brake fluid being displaced out of the brake master cylinder into the hydraulic cylinder of the pedal travel simulator counter to the spring force of the pedal travel simulator. Via the piston travel of the pedal travel simulator and the pressure exerted by the driver, the driver's braking requirement is determined by travel and pressure sensors (not illustrated) on the pedal travel simulator and on the hydraulic assembly and is converted into a braking manoeuver in the control apparatus by software as a result of the activation of the hydraulic assembly.

In the event of a fault or of the failure of the on-board system in the motor vehicle, the brake system assumes a state having a purely hydromechanical auxiliary brake circuit. For this purpose, the inlet valves of the hydraulic assembly separate the pressure supply from the brake lines of the wheel brakes, and the two isolating valves CVVA, CVHA connect the two pressure chambers of the tandem brake master cylinder to the two brake circuits of the motor vehicle. As a result, the vehicle continues to remain brakeable, albeit without power assistance, by way of muscular power due to the actuation of the brake pedal 1.

The operation and connection of the various valves described hitherto in the various operating modes of the brake control are sufficiently known from hydromechanical dual-circuit brake systems, ABS, ASR and ESP brake systems already introduced and do not need to be dealt with in detail here. For the sake of completeness, they have been treated again briefly in outline for the application of the invention and for understanding the invention.

The present invention, then, resides in the configuration of a pedal travel simulator and the coupling of a hydraulic booster cylinder 7 to a spring-loaded cylinder 8 equipped with a strengthened compression spring 9. The compression spring is in this case configured with a strength such and is prestressed in the spring-loaded cylinder with a force such that, in all situations to be expected in the event of the failure of the electrohydraulic brake components or the failure of the on-board system, it is always ensured that at least part of the brake fluid possibly contained in the pedal travel simulator is returned into the auxiliary brake circuit even when the brake pedal is actuated with full muscular power.

Design rules for the compression spring have already been presented in connection with the advantages of the invention. From the legal provisions and from the structural conditions of the brake system, the person skilled in the art can determine for any specific brake system the minimum required prestress of the compression spring which is necessary for the solution according to the invention. In view of the multiplicity of possible structural dimensions of the individual components of the brake system, it does not seem necessary or expedient here to refer to actual dimensions and sizes.

Nor do the legal regulations refer to the dimensioning of the brake systems, although a person skilled in the art could not infer a lack of clarity from this. The hydraulic cylinder of the pedal travel simulator is coupled with its booster piston 11 to the piston 12 of the spring-loaded cylinder. Preferably, the pedal travel simulator is designed with a one-part housing which comprises both the spring-loaded cylinder and the hydraulic cylinder. In this one-piece embodiment of the pedal travel simulator, the booster piston 11 and the piston 12 of the spring-loaded cylinder are preferably coupled via one and the same piston rod. The spring-loaded piston and the booster piston then form a double piston.

In another illustrated embodiment of the invention, the hydraulic booster cylinder 7 and the spring-loaded cylinder 8 may also be separate components. The coupling of the two pistons from the hydraulic cylinder and from the spring-loaded cylinder does not then have to take place via a single piston rod, but, instead, the two piston rods from the hydraulic cylinder and from the spring-loaded cylinder may then be connected to one another via a linkage articulated on the piston rods or via a hydraulic operative connection.

In all the embodiments of the pedal travel simulator, because of the strong compression spring and the high prestressing force with which the compression spring is installed in the spring-loaded cylinder, hydraulic assistance is required in order to actuate the pedal travel simulator when the electrohydraulic brake system is operating normally. Consequently, the hydraulic booster cylinder 7 is connected via two hydraulic valves 4, 5 and naturally via hydraulic lines both to the pressure side of the pressure supply 2 and to the brake fluid reservoir 6 or to the suction side of the pressure supply 2 or to the return line of the hydraulic assembly.

For this purpose, the pressure line D of the pressure supply is connected to two series-connected 2/2-way hydraulic valves 4, 5, to the suction line S of the pressure supply or (not illustrated) to the return line R to the brake fluid reservoir. The first valve, as seen from the pressure side, is in terms of its function and action a pressure-loading valve 5 and the valve following in series is in terms of its function and action a pressure-relieving valve 4. The pressure-loading valve 5 and pressure-relieving valve 4 are in each case self-resetting hydraulic valves. The pressure-relieving valve and the pressure-loading valve are electrical solenoid valves which are activated and switched by the control apparatus ECU of the brake system. The pressure-loading valve and the pressure-relieving valve are connected to a hydraulic line which is itself connected to the hydraulic booster cylinder 7 of the pedal travel simulator via a three-way branch 10. The booster piston 11 of the pedal travel simulator divides the hydraulic booster cylinder into an inflow-side chamber 13 and a return-side chamber 14. The inflow-side chamber 13 is hydraulically connected to the pressure side of the pressure supply via the pressure-loading valve 5 and is loaded with pressure when the brake pedal 1 is actuated. The return-side chamber 14 is connected permanently to the brake fluid reservoir 6.

The inflow-side pressure chamber 15 of the spring-loaded cylinder 8 is permanently connected hydraulically to one of the two pressure chambers of the tandem brake master cylinder. The spring chamber 16 of the spring-loaded cylinder 8 is permanently connected hydraulically to the brake fluid reservoir 6.

The functional interaction between brake master cylinder, pedal travel simulator, pressure supply, pressure-loading valve 5 and pressure-relieving valve 4 is as follows. When the brake system is operating normally, the two isolating valves CVVA, CVHA are in their closed position, so that the tandem brake master cylinder is separated from the hydraulic assembly. On account of this, however, the brake pedal 1 itself is not blocked, since, when the brake pedal is actuated, the hydraulic fluid is pressed into the pedal travel simulator, with the assistance of the hydraulic booster cylinder, by the piston actuated by the brake pedal. The degree of assistance by the hydraulic booster cylinder 7 is set by the connection of the pressure-loading valve 5 and of the pressure-relieving valve 4. The control of the connection is carried out by the control apparatus ECU of the brake system by a pedal travel/pedal force characteristic filed in the control apparatus.

For this purpose, the piston travel in the tandem brake master cylinder is measured, for example, by a travel sensor 17 and the desired brake pressure is measured by a pressure sensor 18 at one of the pressure chambers of the tandem brake master cylinder. The travel sensor and pressure sensor transmit their measurement values, after the latter have been converted into a voltage signal U, to the control apparatus ECU.

In the control apparatus ECU, the measurement values for the desired brake pressure are converted by software into control commands for the valves of the hydraulic assembly and consequently for the actual brake pressure prevailing at the wheel brakes and, according to the invention, also into control commands for opening and closing the pressure-loading valve 5 and the pressure-relieving valve 4. The piston travel in the tandem brake master cylinder is in this case a measure of the pedal travel and the pressure in the pressure chamber of the tandem brake master cylinder is a measure of the pedal force to be set. The driver's braking requirement is determined in the control apparatus from the pedal travel and the pedal force. The valves of the brake system which are activated by the control apparatus are in this case actuators.

In the control apparatus itself, the sensor/actuator relations are stored in characteristic diagrams, so that an unequivocal actuator data record and consequently an unequivocal activation of the brake system or of the valves of the brake system are filed for each sensor data record. In the case of the nonlinear pedal travel/pedal force relation desired according to the invention, the characteristic diagram for activating the pressure-relieving valve consists of a nonlinear characteristic in which the brake pressure rises superproportionately, preferably progressively, with the pedal travel. This is achieved in that, with an increasing pedal travel, the degree of closing of the pressure-relieving valve 4 increases superproportionately, preferably progressively.

By contrast, at the start of braking, that is to say when the initial pedal travel is still small, the pressure-relieving valve is closed or at least virtually closed, whereas the pressure-loading valve 5 has its greatest degree of opening, so that, at the start of brake pedal actuation, there is maximum booster assistance for compressing the very strong compression spring in the spring-loaded cylinder of the pedal travel simulator. With an increasing pedal travel, the degree of opening of the pressure-loading valve decreases superproportionately, preferably progressively with a growing pedal travel. Such characteristics can best be tracked in regulating terms by way of proportional valves. Expediently, therefore, the pressure-relieving valve 4 and the pressure-loading valve 5 are proportional valves.

In a simpler, less preferred embodiment, the pressure-relieving valve may also be designed as a switching valve. In this case, the nonlinear pedal travel/pedal force characteristic would have to be tracked by clocking, that is to say the rapid time-controlled opening and closing of the switching valve. In a similar way to pulse width control, with an increasing pedal travel, the time intervals in which the pressure-relieving valve is closed would then have to increase superproportionately, preferably progressively, with a growing pedal travel. This would, however, result, under some circumstances, in a slight vibration of the brake pedal which could give a driver of a motor vehicle an unpleasant sensation.

A second main advantage of the invention arises in the event of a fault of the electrohydraulic brake system. In the event of a fault, all four inlet valves of the hydraulic assembly for the four wheel brakes are switched into their closed state by the control apparatus. If the control apparatus fails, the inlet valves automatically assume the closed state as a consequence of design, if there is a voltage failure in the drive of the valves. Due to the resetting of the valves which is caused by spring force, the closed state is assumed automatically in the event of a voltage failure. By all the inlet valves being closed, the pressure supply 2 is uncoupled from the brake circuits. At the same time, the isolating valves CVVA, CVHA, by means of which the hydraulic assembly is uncoupled from the tandem brake master cylinder during normal braking, open. As a consequence of design, the isolating valves assume the open position when activation is absent or in the event of a voltage failure in the actuator of the isolating valves.

Since the resetting of the isolating valves is caused by spring force, the open position is assumed automatically in the event of a voltage failure. Likewise, simultaneously with the resetting of the isolating valves and of the inlet valves, the pressure-relieving valve 4 is opened completely and the pressure-loading valve 5 closed completely for the connection of the pedal travel simulator. These two valves, too, are designed in such a way that, due to resetting by spring force, the dead fallback position just mentioned is assumed automatically in the event of a failure of activation or in the event of a failure of the voltage supply. As a result of these changes in the valve positions, the electrohydraulic brake system is then at the fallback level or in the auxiliary braking mode. The valve positions have activated the auxiliary brake circuit.

As regards the auxiliary brake circuit, the primary pressure chamber 19 of the tandem master cylinder is connected to the wheel brakes of the rear axle brake circuit by a hydraulic line via the open isolating valve CVHA for the rear axle brake circuit. The secondary second pressure chamber 20 of the tandem brake master cylinder is then connected to the wheel brakes of the front axle brake circuit by a hydraulic line via the open isolating valve CVVA for the front axle brake circuit.

In the auxiliary braking mode, there is no longer booster assistance of the pedal travel simulator on account of the opening of the pressure-relieving valve 4 and on account of the closing of the pressure-loading valve 5. By the pressure-relieving valve 4 being opened, the compression spring 9 in the spring-loaded cylinder can press the booster piston 11 and the piston 12 of the spring-loaded cylinder in each case into the inlet-side end position. As a result, brake fluid, which has possibly been contained in the inlet-side pressure chamber 15 of the spring-loaded cylinder, is pressed into the auxiliary brake circuit for the rear axle. According to the invention, the prestress of the compression spring in the spring-loaded cylinder of the pedal travel simulator is in this case such that the compression spring can apply in the pressure chamber 15 at least that pressure which is necessary to achieve the minimum decelerations laid down according to StVZO. Preferably, the prestress of the compression spring 9 is such that the compression spring can apply in the pressure chamber 15 at least that pressure which is necessary in order to achieve a locking of the wheel brakes in the case of a maximum coefficient of static friction of the wheels on the road.

When the brake pedal is actuated, therefore, in the event of auxiliary braking, brake fluid can no longer flow into the pedal travel simulator. The brake pressure applied by the driver by pedal pressure is transmitted to the wheel brakes of the rear axle from the first primary pressure chamber of the tandem brake master cylinder by via hydraulic lines. At the same time, when the brake pedal is actuated, the secondary piston of the tandem brake master cylinder is actuated, and the brake pressure in the secondary pressure chamber is transmitted to the wheel brakes of the front axle by means of hydraulic lines.

The foregoing gives rise to two additional advantages of an electrohydraulic brake system which is designed with a pedal travel simulator according to the invention. First, with a brake pedal not actuated, brake fluid which has been conveyed from the tandem brake master cylinder into the pedal travel simulator is conveyed back into the auxiliary brake circuit again as a result of the high prestress of the compression spring of the pedal travel simulator. There is a volume return of the brake fluid contained in the pedal travel simulator either into the tandem brake master cylinder and the brake fluid reservoir or into the brake cylinders of the wheel brakes of the connected auxiliary brake circuit. In the embodiment of FIG. 1, the auxiliary brake circuit for the rear wheels is connected to the pedal travel simulator. The auxiliary brake circuit for the front wheels or another combination, permissible according to the licensing provisions for motor vehicles, of front wheels and rear wheels, as an auxiliary brake circuit, could, of course, also be connected to the pedal travel simulator.

Should the electrohydraulic brake system fail when the brake pedal is actuated and pressed, the brake fluid volume which was conveyed out of the tandem brake master cylinder into the pedal travel simulator where it would be lost for auxiliary braking is conveyed back into the auxiliary brake circuit again by virtue of the inventive measure of volume return, specifically with the brake pedal actuated, without the braking operation being interrupted. In this case, in previously known electrohydraulic brake systems, the brake pedal must be released so that brake fluid can flow from the pedal travel simulator back into the auxiliary brake circuit. In a hazardous situation, therefore, in the case of auxiliary braking with previously known electrohydraulic brake systems, valuable braking travel is sometimes uselessly wasted. In the above-outlined case of auxiliary braking, the present invention considerably shortens the braking travel and therefore increases safety for all road users.

1-33. (canceled)

34. A device for an electrohydraulic brake system, comprising a tandem brake master cylinder, a pedal travel simulator, a pressure supply or at least one pressure accumulator, a control apparatus and a plurality of hydraulic valves wherein the pedal travel simulator is a spring-loaded cylinder with a coupled hydraulic booster cylinder, is connected hydraulically, via a pressure-loading valve, to a pressure side of the pressure supply or of the at least one pressure accumulator and, via a pressure-relieving valve, to a suction side of the pressure supply, to the brake fluid reservoir or to a return line of the hydraulic assembly such that, in a normal operating state of the brake system, the pressure-loading valve and the pressure-relieving valve are actuatable by a pedal travel/pedal force characteristic or, in the event of a fault in the brake system, the pressure-loading valve is closed and the pressure-relieving valve is opened, and the compression spring of the pedal travel simulator presses a piston of the spring-loaded cylinder into an inlet-side end position thereof.

35. The device as claimed in claim 34, wherein the pressure-loading valve, the pressure-relieving valve and the pedal travel simulator are a unitary member.

36. The device as claimed in claim 34, wherein at least one of the two hydraulic valves is a proportional valve.

37. The device as claimed in claim 34, wherein the hydraulic valves are proportional valves.

38. The device as claimed in claim 34, wherein the spring-loaded cylinder and the hydraulic booster cylinder are a unitary member.

39. The device as claimed in claim 34 wherein, in which the spring-loaded cylinder and the hydraulic booster cylinder are separate.

40. The device as claimed in claim 34, wherein the compression spring is dimensioned and the compression spring is prestressed such that, in order to actuate the pedal travel simulator and consequently compress the compression spring, a minimum brake pressure is necessary which is specific to the brake systems so that a legally prescribed mean deceleration is at least achieved when a legally prescribed maximum pedal force is applied.

41. The device as claimed in claim 40, wherein the means deceleration is 2.9 m/s² and the maximum pedal force is 500 N.

42. The device as claimed in claim 34, wherein the compression spring is dimensioned and the compression spring is prestressed such that, in order to actuate the pedal travel simulator and consequently compress the compression spring, a pressure is necessary which is higher than the brake pressure which is specific to the brake systems and at which the wheels lock at a maximum coefficient of static friction.

43. The device as claimed in claim 34, wherein the pedal travel/pedal force characteristic has a progressive, travel/force profile which is linear or nonlinear.

44. An electrohydraulic brake system with a hydraulic assembly for at least two brake circuits, comprising at least two isolating valves, an electronic control apparatus, a pressure supply or at least one pressure accumulator, a plurality of sensors for determining a braking requirement, and an actuating unit having a brake pedal, a tandem brake master cylinder and a pedal travel simulator, wherein the pedal travel simulator includes a spring-loaded cylinder with a coupled hydraulic booster cylinder, connected hydraulically, via a pressure-loading valve, to a pressure side of the pressure supply or of the pressure accumulator and, via a pressure-relieving valve, to a suction side of the pressure supply, or to the brake fluid reservoir or to a return line of the hydraulic assembly.

45. The electrohydraulic brake system as claimed in claim 44, wherein the pressure-loading valve, the pressure-relieving valve and the pedal travel simulator are an integrated unit.

46. The electrohydraulic brake system as claimed in claim 44 wherein, the pedal travel simulator and the hydraulic assembly are a unitary piece.

47. The electrohydraulic brake system as claimed in claim 44, wherein the pedal travel simulator and the tandem brake master cylinder are a unitary piece.

48. The electrohydraulic brake system as claimed in claim 44 wherein, the pedal travel simulator is one of the pressure supply or at least one pressure accumulator are a unitary piece.

49. The electrohydraulic brake system as claimed in claim claim 44, wherein the pedal travel simulator is a separate component.

50. The electrohydraulic brake system as claimed in claim 44, wherein at least one of the two hydraulic valves is a proportional valve.

51. The electrohydraulic brake system as claimed in claim 44, wherein the hydraulic valves are proportional valves.

52. The electrohydraulic brake system as claimed in claim 44, wherein the spring-loaded cylinder and the hydraulic booster cylinder are a unitary member.

53. The electrohydraulic brake system as claimed in claim 44, wherein the spring-loaded cylinder and the hydraulic booster cylinder are spaced apart components.

54. The electrohydraulic brake system as claimed in claim 44, wherein the compression spring is dimensioned and the compression spring is prestressed such that, in order to actuate the pedal travel simulator and consequently compress the compression spring, a minimum brake pressure is necessary which is specific to the brake systems so that a legally prescribed mean deceleration is at least achieved when a legally prescribed maximum pedal force is applied.

55. The electrohydraulic brake system as claimed in claim 54, wherein the means deceleration is 2.9 m/s² and the maximum pedal force is 500 N.

56. The electrohydraulic brake system as claimed in claim 44, wherein the compression spring is dimensioned and the compression spring is prestressed such that, in order to actuate the pedal travel simulator and compress the compression spring, a pressure is necessary which is higher than the brake pressure which is specific to the brake systems and at which the wheels lock at a maximum coefficient of static friction.

57. The electrohydraulic brake system as claimed in claim 44, wherein the pedal travel/pedal force characteristic has a progressive, travel/force profile which is linear or nonlinear.

58. A pedal travel simulator comprising of a spring-loaded cylinder and a hydraulic booster cylinder having a piston operatively connected mechanically or hydraulically to the piston of a spring-loaded cylinder.

59. The pedal travel simulator as claimed in claim 58, wherein the spring-loaded cylinder and the hydraulic booster cylinder constitute a unitary piece.

60. The pedal travel simulator as claimed in claim 58, wherein the spring-loaded cylinder and the hydraulic booster cylinder are separate components.

61. The pedal travel simulator as claimed in claim 58, wherein the piston of the spring-loaded cylinder and the piston of the hydraulic booster cylinder are connectable via a common piston rod.

62. The pedal travel simulator as claimed in claim 58, wherein, the piston of the hydraulic booster cylinder is articulated on the piston of the spring-loaded cylinder via a linkage.

63. A method for activating an electrohydraulic brake system with a hydraulic assembly for at least two brake circuits, having at least two isolating valves, an electronic control apparatus, a pressure supply or at least one pressure accumulator, a plurality of sensors configured to determine a braking requirement, and an actuating unit having a brake pedal, a tandem brake master cylinder and a pedal travel simulator, wherein the pedal travel simulator has a spring-loaded cylinder with a coupled hydraulic booster cylinder connected hydraulically, via a pressure-loading valve, to a pressure side of the pressure supply or of the at least one pressure accumulator and, via a pressure-relieving valve to a suction side of the pressure supply, a brake fluid reservoir or to a return line of the hydraulic assembly, comprising in a normal operating state of the brake system, actuating the pressure-loading valve and the pressure-relieving valve by a pedal travel/pedal force characteristic and, in the event of a fault in the brake system, causing the pressure-loading valve and the pressure-relieving valve to fall into their respective fallback positions and the compression spring of the pedal travel simulator to press the piston of the spring-loaded cylinder into an inlet-side end position thereof.

64. The method as claimed in claim 63, wherein the pressure-loading valve is actuatable by the pedal travel/pedal force characteristic which is linear or nonlinear.

65. The method as claimed in claim 63, wherein the pressure-relieving valve is actuatable by the pedal travel/pedal force characteristic which is linear or nonlinear.

66. The method as claimed in claim 63, wherein the pressure-relieving valve and the pressure-loading valve are actuatable by the pedal travel/pedal force characteristic which is nonlinear.

67. The method as claimed in claim 64, wherein the nonlinear pedal travel/pedal force characteristic rises superproportionately or progressively with an increasing pedal travel.

68. The method as claimed in claim 63, further comprising, in the event of a fault in a component of the electrohydraulic brake system or in the event of a failure of the control apparatus, switching over the electrohydraulic brake system into an auxiliary braking mode, and conveying brake fluid contained in the pedal travel simulator into the auxiliary brake circuit
